(19) United States
(12) Patent Application Publication
(10) Pub. No.: US 2024/0408744 A1
(43) Pub. Date: Dec. 12, 2024

(54) ROBOT AND SETUP DEVICE COMPRISING IT

(71) Applicant: LG ELECTRONICS INC., Seoul (KR)

(72) Inventors: Pilyoung JEON, Seoul (KR); Seungryong HAN, Seoul (KR); Jinhyeok PARK, Seoul (KR)

(73) Assignee: LG ELECTRONICS INC., Seoul (KR)

(21) Appl. No.: 18/701,002

(22) PCT Filed: Jan. 11, 2022
(86) PCT No.: PCT/KR2022/000455

§ 371 Date: Apr. 12, 2024

(51) Int. Cl. B25J 9/06; B25J 5/00; B62B 5/04

(52) U.S. Cl. CPC B25J 9/06; B25J 5/007; B62B 5/04

(57) ABSTRACT

A robot and a setup device comprising the same are disclosed. The robot may include: a moving cart; and a robot arm mounted on the moving cart, wherein the moving cart may include: a cabinet on which the robot arm is mounted; a plurality of roller blocks coupled to a lower side of the cabinet; and a guide pin elongated in a downward direction of the cabinet and positioned between the plurality of roller blocks, wherein each of the plurality of roller blocks may include: a roller mount coupled to the lower side of the cabinet; and a roller rotatably coupled to the roller mount, and wherein the roller mount may have a curved side that forms an inflection point with respect to an outer circumference of the roller.

### TECHNICAL FIELD

The present disclosure relates to a robot and a setup device including the robot. More particularly, the present disclosure relates to a collaborative robot (co-robot, cobot) and a setup device for facilitating the setup of the collaborative robot.

### BACKGROUND ART

A robot is a machine capable of carrying out a series of actions automatically. Robots have been an integral part to achieve production automation, and have been evolved into highly advanced intelligent robots. An intelligent robot refers to a robot that perceives the environment, makes decisions, and performs necessary tasks autonomously.

Intelligent robots are classified into two main categories: industrial robots and service robots. Unlike traditional industrial robots that typically work separately from humans, collaborative robots are designed to work alongside humans in a shared workspace by assisting or replacing human operators in performing tasks. Such collaborative robots are intended to physically interact with humans in a shared workspace to improve the productivity. By contrast, service robots are designed to provide various kinds of services in social infrastructure, with the goal of enhancing the convenience of daily life.

Recently, numerous research has been conducted on intelligent robots.

### DISCLOSURE OF INVENTION

### Technical Problem

It is an objective of the present disclosure to solve the above and other problems.

Another object may be to provide a robot that can increase the accuracy of the setup of a collaborative robot, and a setup device including the same.

Another object may be to provide a robot that can facilitate the setup of a collaborative robot, and a setup device including the same.

### Technical Solution

According to an aspect of the present disclosure for achieving the above object, a robot may include: a moving cart; and a robot arm mounted on the moving cart, wherein the moving cart may include: a cabinet on which the robot arm is mounted; a plurality of roller blocks coupled to a lower side of the cabinet; and a guide pin elongated in a downward direction of the cabinet and positioned between the plurality of roller blocks, wherein each of the plurality of roller blocks may include: a roller mount coupled to the lower side of the cabinet; and a roller rotatably coupled to the roller mount, and wherein the roller mount may have a curved side that forms an inflection point with respect to an outer circumference of the roller.

### Advantageous Effects of Invention

A robot and a setup device including the robot according to the present disclosure has the following effects.

According to at least one of the embodiments of the present disclosure, it is possible to provide a robot capable of increasing the accuracy of the setup of a collaborative robot, and a setup device including the same.

According to at least one of the embodiments of the present disclosure, it is possible to provide a robot capable of facilitating the setup of a collaborative robot, and a setup device including the same.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 8 are diagrams illustrating examples of a robot and a setup device including the robot, according to embodiments of the present disclosure.

### MODE FOR INVENTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. In contrast, when a component is referred to as being “directly connected to” or “directly coupled to” another component, there are no intervening components present.

As used herein, a singular representation is intended to include a plural representation unless the context clearly indicates otherwise.

In the following description, even if an embodiment is described with reference to a specific figure, if necessary, reference numeral not shown in the specific figure may be referred to, and reference numeral not shown in the specific figure is used when the reference numeral is shown in the other figures.

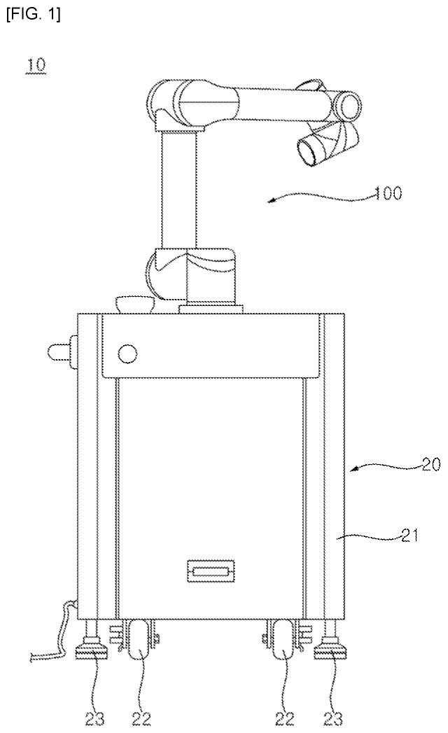

Referring to FIG. 1, a robot 10 may include a moving cart 20 and a robot arm 100. The robot arm 100 may be mounted on the moving cart 20. The robot arm 100 may be an articulated arm 100. The moving cart 20 may provide coordinates to the robot arm 100, and the robot arm 100 may move based on the coordinates provided by the moving cart 20.

The moving cart 20 may include a cabinet 21 and a wheel 22. The cabinet 21 may define an accommodation space therein. The robot arm 100 may be rotatably mounted on the cabinet 21. The wheel 22 may be installed on a bottom of the cabinet 21. The wheel 22 may allow the cabinet 21 to move freely.

A foot 23 may be installed on the bottom of the cabinet 21 while being adjacent to the wheel 22. The foot 23 may limit the movement of the cabinet 21. The foot 23 may move in an up-and-down or vertical direction of the cabinet 21. The foot 23 may be stored inside the cabinet 21, and may be extendable in length so that its length may be increased when moving to an outside of the cabinet 21. As the length of the foot 23 is increased, the movement of the cabinet 21 may be inhibited, so that the cabinet 21 may be fixed or secured to the floor.

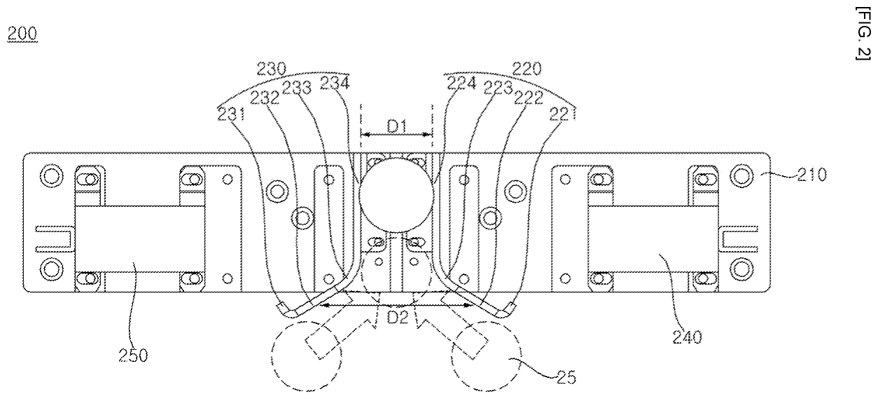

Referring to FIG. 2, a setup device 200 may include a base 210, a guide wall (220, 230), and an anchor shaft (240, 250). The base 210 may be an elongated plate. The guide wall (220, 230) may be provided in plurality. The plurality of guide walls (220, 230) may include a first guide wall 220 and a second guide wall 230.

The first guide wall 220 may be an elongated plate, and may be curved in some sections. The first guide wall 220 may include a first linear portion 224, a curved portion 223, a second linear portion 222, and a tab 221. The first linear portion 224 may extend vertically on an upper surface of the base 210. The first linear portion 224 may be elongated in a widthwise direction of the base 210, and may be fixed to the base 210. The curved portion 223 may extend from one end of the first linear portion 224, and may be bent from the widthwise direction of the base 210 to a lengthwise direction of the base 210. The second linear portion 222 may extend from one end of the curved portion 223. The curved portion 223 may be positioned between the first linear portion 224 and the second linear portion 222. A length of the second linear portion 222 may be less than a length of the first linear portion 224. The tap 221 may be formed at an end of the second linear portion 222. The tap 221 may be bent from the second linear portion 222 toward the base 210.

The second guide wall 230 may be an elongated plate, and may be curved in some sections. The second guide wall 230 may include a first linear portion 234, a curved portion 233, a second linear portion 232, and a tab 231. The first linear portion 234 may extend vertically on the upper surface of the base 210. The first linear portion 234 may be elongated in the widthwise direction of the base 210, and may be fixed to the base 210. The curved portion 233 may extend from one end of the first linear portion 234, and may be bent from the widthwise direction of the base 210 to the lengthwise direction of the base 210. The second linear portion 232 may extend from one end of the curved portion 233. The curved portion 233 may be positioned between the first linear portion 234 and the second linear portion 232. A length of the second linear portion 232 may be less than a length of the first linear portion 234. The tap 231 may be formed at an end of the second linear portion 232. The tap 231 may be bent from the second linear portion 232 toward the base 210.

A first distance D1 from the first linear portion 224 of the first guide wall 220 to the first linear portion 234 of the second guide wall 230 may be less than a second distance D2 from the second linear portion 222 of the first guide wall 220 to the second linear portion 232 of the second guide wall 230. The first guide wall 220 and the second guide wall 230 may form a Y-shape.

The anchor shaft (240, 250) may be provided in plurality. The anchor shaft (240, 250) may have a cylindrical shape, and may be elongated in a direction parallel to the lengthwise direction of the base 210. The plurality of anchor shafts (240, 250) may include a first anchor shaft 240 and a second anchor shaft 250. The first anchor shaft 240 may be disposed opposite the second guide wall 230 with respect to the first guide wall 220. The first anchor shaft 240 may be fixed on the base 210. The second anchor shaft 250 may be disposed opposite the first guide wall 220 with respect to the second guide wall 230. An axial direction of the first anchor shaft 240 and an axial direction of the second anchor shaft 250 may be located on the same line. The first anchor shaft 240 may be opposite or symmetrical to the second anchor shaft 250 with respect to the guide wall 220, 230. As an outer surface of each anchor shaft 240, 250 is precisely machined, the plurality of anchor shafts 240 and 250 may have the same diameter.

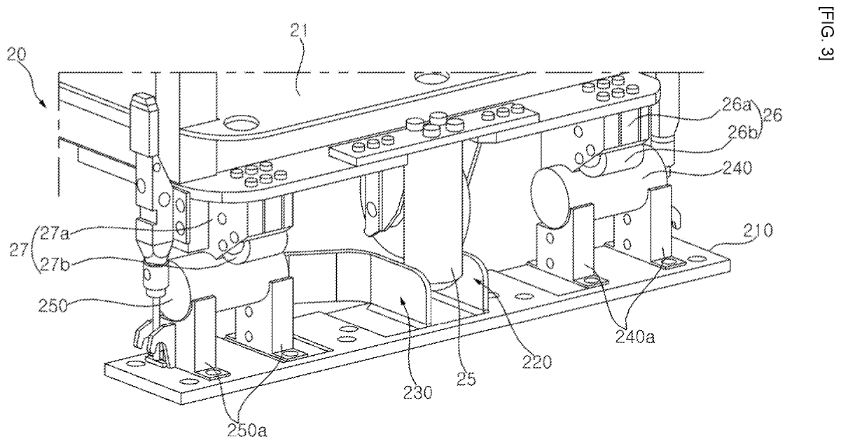

Referring to FIG. 3 together with FIG. 2, the moving cart 20 may include a guide pin 25. The guide pin 25 may extend by protruding in a downward direction of the cabinet 21. The guide pin 25 may be elongated, and may be fixed to a lower side of the cabinet 21. A diameter of the guide pin 25 may be equal to the first distance D1 between the first linear portion 224 of the first guide wall 220 and the second linear portion 234 of the second guide wall 230.

When the moving cart 20 approaches the base 210, the guide pin 25 of the moving cart 20 may guide the moving cart 20 along the guide wall 220, 230. When the guide pin 25 approaches or contacts the second linear portion 222 of the first guide wall 220 or the second linear portion 232 of the second guide wall 230, the guide pin 25 may be guided by the curved portion 223, 233 and the first linear portion 224, 234 so as to approach the proper position.

When the guide pin 25 of the moving cart 20 approaches closer to an end of the second linear portion 222 of the first guide wall 220 or an end of the second linear portion 232 of the second guide wall 230, the guide pin 25 may be guided by the tap 221, 231. Due to the tap 221, 231, the guide pin 25 may be guided to the curved portion 223, 233 of the guide wall 220, 230 without being out of the first guide wall 220 or the second guide wall 230. Accordingly, the guide pin 25 may approach the proper position.

The moving cart 20 may include a roller (26, 27). The roller (26, 27) may be provided in plurality. The plurality of rollers (26, 27) may include a first roller block 26 and a second roller block 27. The first roller block 26 may be disposed opposite the second roller block 27 with respect to the guide pin 25. The first roller block 26 and the second roller block 27 may be fixed to the lower side of the cabinet 21.

The first roller block 26 may include a wheel mount 26a and a wheel 26b. The wheel mount 26a may be referred to as a roller mount 26a. The wheel 26b may be referred to as a roller 26b. The wheel mount 26a may be coupled or fixed to the lower surface of the cabinet 21. The wheel 26b may rotate on the wheel mount 26a. The second roller block 27 may include a wheel mount 27a and a wheel 27b. The wheel mount 27a may be referred to as a roller mount 27a. The wheel 27b may be referred to as a roller 27b. The wheel mount 27a may be coupled or fixed to the lower surface of the cabinet 21. The wheel 27b may rotate on the wheel mount 27a.

A first anchor mount 240a and a second anchor mount 250a may be fixed on the base 210. The first anchor shaft 240 may be positioned on the first anchor mount 240a. The first anchor shaft 240 may be coupled or fixed to the first anchor mount 240a. The second anchor shaft 250 may be positioned on the second anchor mount 250a. The second anchor shaft 250 may be coupled or fixed to the second anchor mount 250a.

As the guide pin 25 approaches the proper position by the guide wall 220, 230, the roller 26, 27 may be placed on the anchor shaft 240, 250. The first roller block 26 may ride over the first anchor shaft 240, and the second roller block 27 may ride over the second anchor shaft 250.

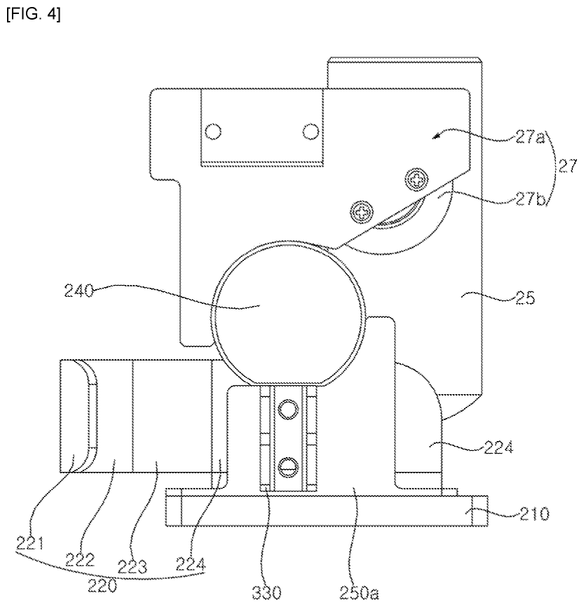

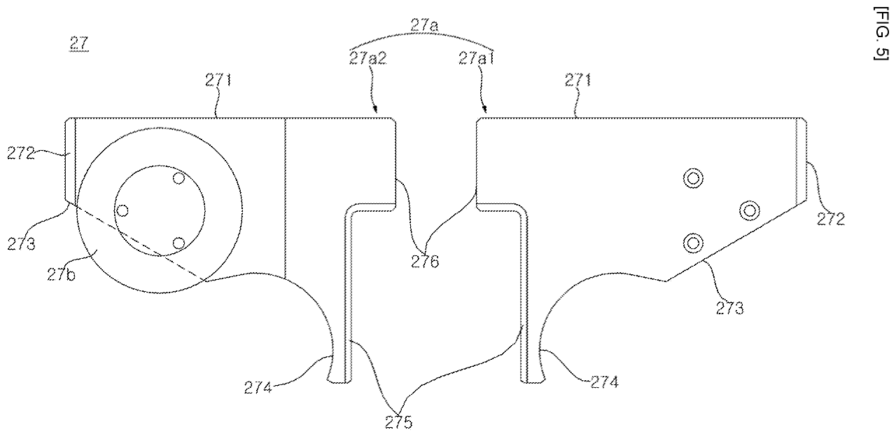

Referring to FIGS. 4 and 5, the wheel mount 27a may include a first part 27a1 and a second part 27a2. The first part 27a1 and the second part 27a2 may face each other. The wheel 27b may be positioned between the first part 27a1 and the second part 27a2, and may be rotatably coupled to the first part 27a1 and the second part 27a2. The first part 27a1 and the second part 27a2 may have an overall plate shape.

The wheel mount 27a may include a first horizontal side 271, a first vertical side 272, a second vertical side 275, a third vertical side 276, an inclined side 273, and a curved side 274. The first horizontal side 271 may define an upper side of the wheel mount 27a. The first vertical side 272 may define a lateral side of the wheel mount 27a. The second vertical side 276 and the third vertical side 275 may define a lateral side of the wheel mount 27a, and may face the first vertical side 272. The second vertical side 276 may be bent and extend from the first horizontal side 271, and the third vertical side 275 may extend from the second vertical side 276 while forming a step. The inclined side 273 may extend from the first vertical side 272, and may be inclined with respect to the first horizontal side 271. For example, the inclined side 273 may form an obtuse angle with respect to the first vertical side 272, and may form an acute angle with respect to the first horizontal side 271. For example, the curved side 274 may form a circular arc. The curved side 274 may connect the inclined side 273 and the third vertical side 275.

A curvature of the curved side 274 may correspond to a curvature of the anchor shaft 240. The wheel 27b may be rotatably coupled to the wheel mount 27a while being adjacent to the curved side 274. The wheel 27b may be positioned between the first vertical side 272 and the curved side 274. The wheel 27b may be positioned on the inclined side 273. An outer circumference of the wheel 27b and the curved side 274 may form an inflection point. For example, as the wheel 27b rides over the anchor shaft 240, the curved side 274 of the wheel mount 27a may be placed on the anchor shaft 240. In this case, the curved side 274 of the wheel mount 27a may come into contact with an outer circumferential surface of the anchor shaft 240. The precision-machined outer circumferential surface of the anchor shaft 240 and the curved side 274 of the wheel mount 27a may come into close contact with each other.

Accordingly, the moving cart 20 (see FIG. 3) may be aligned with the anchor shaft 240, and may be securely positioned on the anchor shaft 240. In addition, it is possible to prevent the separation of the moving cart 20 from the anchor shaft 240.

A latch holder 330 may be coupled or fixed to the anchor mount 250a. The latch holder 330 may be elongated. A longitudinal direction of the latch holder 330 may be located at the center of the radius of a cross section of the anchor shaft 240. The latch holder 330 may come into contact with the outer circumferential surface of the anchor shaft 240.

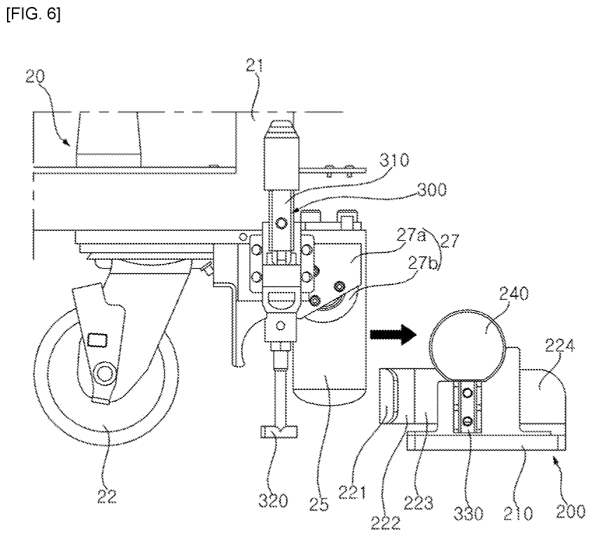

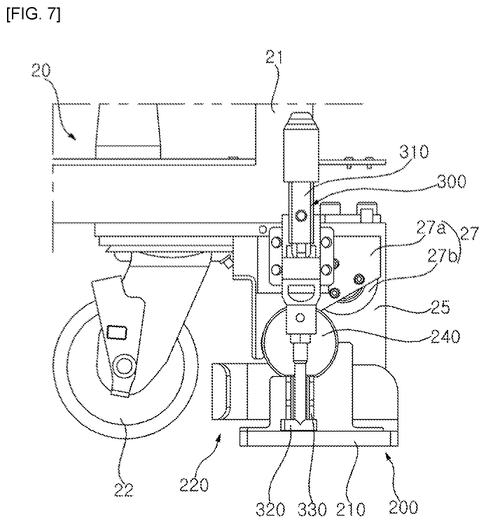

Referring to FIGS. 6 and 7, a clamp 300 may be coupled or fixed to the wheel mount 27a. The clamp 320 may be fixed to a side surface of the cabinet 21 of the moving cart 20 while being adjacent to the wheel mount 27a. The clamp 300 may include a latch 320 and a lever 310. The latch 320 may be elongated downward from the wheel mount 27a, and the lever 310 may adjust the vertical movement of the latch 320.

When the moving cart 20 approaches the setup device 200, the guide pin 25 may approach the guide wall 220. The guide pin 25 may be guided by the guide wall 220 to be properly positioned to the base 210, and the wheel mount 27a may be positioned on the anchor shaft 240.

The latch 320 may be engaged with the latch holder 330. In order to fix the moving cart 20 to the base 210 while the curved side 274 of the wheel mount 27a is aligned with the anchor shaft 240, the latch 320 may be fixed to the latch holder 330 using the lever 310.

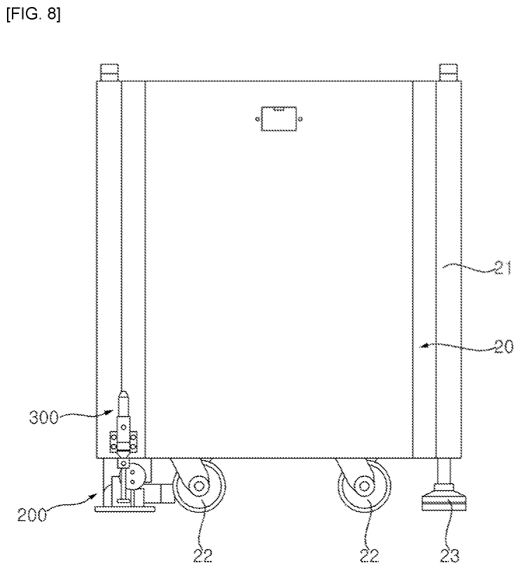

Referring to FIG. 8, the foot 23 may move in the downward direction of the cabinet 21. The foot 23 may move in the downward direction of the cabinet 21 by enough to cause the wheel 22 to be slightly lifted off the floor. The moving cart 20 may be constrained in movement by the setup device 200 and the foot 23.

Referring to FIGS. 1 to 8, a robot may include: a moving cart 20; and a robot arm 100 mounted on the moving cart 20, wherein the moving cart 20 may include: a cabinet 21 on which the robot arm 100 is mounted; a plurality of roller blocks 26 and 27 coupled to a lower side of the cabinet 21; and a guide pin 25 that is elongated in a downward direction of the cabinet 21 and positioned between the plurality of roller blocks 26 and 27, and wherein each of the plurality of roller blocks 26 and 27 may include: a roller mount (26a, 27a) coupled to the lower side of the cabinet 21; and a roller (26b, 27b) rotatably coupled to the roller mount (26a, 27a). The roller mount 27a may have a curved side 274 that forms an inflection point with respect to an outer circumference of the roller 27b.

The curved side 274 may be opposite the cabinet 21 with respect to a center of the roller 27b.

A direction of a rotation axis of the roller 27b may intersect a lengthwise direction of the guide pin 25.

The robot may further include a wheel 22 installed at a lower portion of the cabinet 21 and moving the cabinet 21, the curved side 274 of the roller mount 27a may be positioned between the guide pin 25 and the wheel 22.

The roller mount 27a may further include a vertical side 275 that extends long in the downward direction of the cabinet 21 and is connected to the curved side 274, the vertical side 275 of the roller mount 27a may be positioned between the wheel 22 and the roller 27b.

There is provided a setup device 200 for aligning a position of the moving cart 20 of the robot, the setup device 200 including: a base 210 having an elongated plate shape; a first guide wall 220 forming a wall on the base 210 in a widthwise direction of the base 210 and fixed to the base 210; and a second guide wall 230 facing the first guide wall 220 and fixed to the base 210, a distance D1 between the first guide wall 220 and the second guide wall 230 may correspond to a width of the guide pin 25.

The first guide wall 220 may be bent from the widthwise direction of the base 210 to a lengthwise direction of the base 210 and may be further away from the second guide wall 230, the second guide wall 230 may be bent from the widthwise direction of the base 210 to the lengthwise direction of the base 210 and may be further away from the first guide wall 220.

The setup device 200 may further include: a first anchor shaft 240 which is elongated in a lengthwise direction of the base 210, which has a curvature corresponding to a curved side of a roller mount (26a) of one of the plurality of roller blocks 26 and 27, and which is mounted to the base 210; and a second anchor shaft 250 which is elongated in the lengthwise direction of the base 210, which has a curvature corresponding to a curved side of a roller mount (27a) of a remaining one of the plurality of roller blocks 26 and 27, and which is mounted to the base 210, the second anchor shaft 250 being disposed opposite the first anchor shaft 240 with respect to the first guide wall 220 and the second guide wall 230.

The setup device 200 may further include: a first anchor mount 240a positioned between the base 210 and the first anchor shaft 240 and fixing the first anchor shaft 240 to the base 210; a second anchor mount 250a positioned between the base 210 and the second anchor shaft 250 and fixing the second anchor shaft 250 to be fixed to the base 210; and a latch holder 330 coupled to at least one of the first anchor mount 240a or the second anchor mount 250a.

The robot may further include a latch 300 fixed to one side of the cabinet 21 and engaged with the latch holder 330 when the curved side 274 of the roller mount 27a is aligned with a position of the latch holder 330.

Certain embodiments or other embodiments of the present disclosure described above are not mutually exclusive or distinct from each other. Any or all elements of the embodiments of the present disclosure described above may be combined or combined with each other in configuration or function.

For example, a configuration “A” described in one embodiment of the present disclosure and the drawings, and a configuration “B” described in another embodiment of the present disclosure and the drawings may be combined with each other. Namely, although the combination between the configurations is not directly described, the combination is possible except in the case where it is described that the combination is impossible.

The above detailed description should be construed in all aspects as illustrative and not restrictive. The scope of the disclosure should be determined by reasonable interpretation of the appended claims, and all changes coming within the equivalency range of the disclosure are intended to be embraced in the scope of the disclosure.

1. A robot comprising:
a moving cart; and
a robot arm mounted on the moving cart,
wherein the moving cart comprises:
a cabinet on which the robot arm is mounted;
a plurality of roller blocks coupled to a lower side of the cabinet; and
a guide pin elongated in a downward direction of the cabinet and positioned between the plurality of roller blocks,
wherein each of the plurality of roller blocks comprises:
a roller mount coupled to the lower side of the cabinet; and
a roller rotatably coupled to the roller mount, and
wherein the roller mount has a curved side that forms an inflection point with respect to an outer circumference of the roller.

2. The robot of claim 1, wherein the roller is positioned between the curved side of the roller mount and the cabinet.

3. The robot of claim 2, wherein a direction of a rotation axis of the roller intersects a lengthwise direction of the guide pin.

4. The robot of claim 1, further comprising a wheel installed at a lower portion of the cabinet and moving the cabinet,
wherein a curved portion of the roller mount is positioned between the guide pin and the wheel.

5. The robot of claim 4, wherein the roller mount further comprises a vertical side extending long in the downward direction of the cabinet and adjacent to the curved side, and
wherein the vertical side of the roller mount is positioned between the wheel and the curved side of the roller mount.

6. A setup device for aligning a position of the moving cart of claim 1, the setup device comprising:
a base having an elongated plate shape;
a first guide wall forming a wall on the base in a widthwise direction of the base and fixed to the base; and
a second guide wall facing the first guide wall and fixed to the base,
wherein a distance between the first guide wall and the second guide wall corresponds to a width of the guide pin.

7. The setup device of claim 6, wherein the first guide wall is bent from the widthwise direction of the base to a lengthwise direction of the base and is further away from the second guide wall, and
wherein the second guide wall is bent from the widthwise direction of the base to the lengthwise direction of the base and is further away from the first guide wall.

8. The setup device of claim 6, further comprising:
a first anchor shaft which is elongated in a lengthwise direction of the base, which has a curvature corresponding to a curved side of a roller mount of any one of the plurality of roller blocks, and which is mounted to the base; and
a second anchor shaft which is elongated in the lengthwise direction of the base, which has a curvature corresponding to a curved side of a roller mount of another one of the plurality of roller blocks, and which is mounted to the base,
wherein the first guide wall and the second guide wall are positioned between the first anchor shaft and the second anchor shaft.

9. The setup device of claim 8, further comprising:
a first anchor mount positioned between the base and the first anchor shaft and fixing the first anchor shaft to the base;
a second anchor mount positioned between the base and the second anchor shaft and fixing the second anchor shaft to to the base; and
a latch holder coupled to at least one of the first anchor mount or the second anchor mount.

10. The setup device of claim 9, wherein the robot further comprises a latch fixed to one side of the cabinet and engaged with the latch holder when the curved side of the roller mount is aligned with a position of the latch holder.
